(19) United States
(12) Patent Application Publication
(10) Pub. No.: US 2007/0114096 A1
(43) Pub. Date: May 24, 2007

(54) Modular ladder and tree stand system with pivoting joint

(76) Inventor: Timothy Scott Skipper, Ormond Beach, FL (US)

Correspondence Address: J. WILEY HORTON, ESQUIRE;Pennington, Moore, Wilkinson, Bell & Dunbar, P.A., Post Office Box 10095, Tallahassee, FL, 32302-2095, US

(21) Appl. No.: 11/284,342

(22) Filed: Nov. 21, 2005

(51) Int. Cl. E06C 7/16

(52) U.S. Cl. 182/116

(57) ABSTRACT

A portable modular ladder and tree stand which can be attached to a vertical object to be climbed—such as a tree. The ladder's structure is preferably provided by two or more vertical climbing sticks locked together. These climbing sticks can be secured to the object to be climbed by a securing strap or other conventional means. A set of rungs extend outward from the climbing sticks. The invention also includes a pivoting connection between a climbing stick and a tree stand attached thereto. A set of climbing sticks and associated tree stand can be assembled on the ground and then rotated up against a tree. The pivoting connection allows a user to rotate the tree stand away from the climbing sticks before attaching the tree stand to the tree. A second embodiment includes a swing link and two pivot joints in order to accommodate the complex motion of a camming tree stand.

### BACKGROUND OF THE INVENTION

1. Field of the Invention

This invention relates to the field of ladders and tree stands. More specifically, the invention comprises a modular ladder and hunting tree stand attached together by a pivoting joint.

2. Description of the Related Art

Modular ladders designed to allow the climbing of vertical objects such as trees are disclosed in several prior U.S. patents. Examples include U.S. Pat. No. 5,040,635 to Strickland (1991); U.S. Pat. No. 6,076,634 to Simon (2000); U.S. Pat. No. 6,170,609 to Dech (2001); and U.S. Pat. No. 6,340,071 to Dickemper (2002).

Likewise, tree stands allowing a hunter to remain in an elevated position are widely known. Examples include U.S. Pat. No. 5,097,925 to Walker, Jr. (1992); U.S. Pat. No. 5,862,883 to Carriere (1999); and U.S. Pat. No. 6,246,000 to Johnson (2001). The present invention incorporates elements of the prior art modular ladders and tree stands. It is therefore important for the reader to have a basic understanding of these devices. Illustrations are provided in the following sections. However, the reader should bear in mind that many variations of prior art ladders and tree stands exist. The present invention can be adapted for use with virtually all of these variations. Thus, the versions shown should be viewed as a few examples among many more possibilities.

FIG. 1 shows a prior art climbing stick 10. Column 12 supports a series of staggered rungs 18. Extension 16 descends from the lower end of the column. The column's upper end opens into receiver 14, which is sized to slidably receive an extension 16 from another climbing stick 10. These structures allow two or more climbing sticks to be mated together to form a ladder.

Of course, climbing stick 10 is designed to be attached to a tree. Standoffs 20 are provided to space the column and rungs a small distance away from the tree, in order to provide clearance for the user's feet when he or she climbs the rungs. FIG. 2 shows more detail of standoff 20. Each end of the standoff is provided with a hole 22. These holes allow a securing strap to be affixed to the climbing stick.

FIG. 3 shows the climbing stick with strap 24 affixed to its upper standoff 20. Two straps can normally be attached to a climbing stick. However, once the climbing sticks are linked together into a ladder, one strap per stick is usually sufficient. FIG. 4 shows more detail of strap 24. Each end of the strap is provided with a hook 26 which passes through a hole 22 on the standoff. Adjustment clasp 28 allows the strap to be tightened and secured. Those skilled in the art will know that many different strap and strap securing devices are used—including chains, cables, etc.

FIG. 5 shows a climbing stick 10 affixed to tree 30 by strap 24. The reader will observe that the ends of the two standoffs are drawn tightly against the tree. FIG. 6 shows one type of prior art tree stand 32. It has features common to many tree stands. A seat 38 is joined to a foot rest 34 by an upright 36. For this particular version, foot rest 34 is pivotally attached to upright 36 so that it can be folded. A pair of cables 40 support and stabilize the foot rest when it is folded down into the position shown.

The stand shown is a folding “cam” type, the operation of which is illustrated in FIGS. 7 through 9. In FIG. 7, foot rest 34 is folded upward toward upright 36. FIG. 8 shows the stand placed against tree 30. Strap 24 is secured to the tree stand and drawn fairly tight while pads 42 and upper jaw 44 rest against the tree. The user then forces the foot rest downward in the direction indicated by the arrow. FIG. 9 shows the result. The foot rest has rotated to a horizontal orientation and drawn its supporting cables taut. Pads 42 have been forced hard against the tree. The lower portion of the upright has been rotated outward. These motions create a camming over center effect. Those skilled in the art will realize that strap 24 will be significantly tightened. The result is that the tree stand is held very tightly against the tree, creating a stable platform.

However, the camming motion shown in FIGS. 8 and 9 creates a challenge for the present invention. The combined rotation and translation of the tree stand components must be taken into account when attaching this type of stand to another device, as will be explained subsequently.

FIG. 10 shows the prior art tree stand and climbing sticks in use. Four climbing sticks 10 have been linked together and affixed to tree 30 using a series of straps 24. The user then climbs the linked sticks carrying the tree stand. Tree stand 32 is then affixed to the tree above the top of the ladder formed by the climbing sticks.

In some instances, the tree stand may be attached to the top of the climbing sticks so that the sticks and the stand can be rotated up and against the tree as one unit. U.S. Pat. No. 6,719,093 to Garbs (2004) shows such a device. The position of the ladder and the stand are much the same as shown in FIG. 10, however.

The user must climb the ladder formed by the linked climbing sticks, then climb around and onto the tree stand. This action represents an obvious hazard. It would be advantageous to provide a ladder and tree stand system which allows an easier transition from the ladder to the tree stand.

### BRIEF SUMMARY OF THE INVENTION

The present invention comprises a portable modular ladder and tree stand which can be attached to a vertical object to be climbed—such as a tree. The ladder's structure is preferably provided by two or more vertical climbing sticks locked together. These climbing sticks can be secured to the object to be climbed by a securing strap or other conventional means. A set of rungs extend outward from the climbing sticks.

The invention also includes a pivoting connection between a climbing stick and a tree stand attached thereto. A set of climbing sticks and associated tree stand can be assembled on the ground and then rotated up against a tree. The pivoting connection allows a user to rotate the tree stand away from the climbing sticks before attaching the tree stand to the tree. A second embodiment includes a swing link and two pivot joints in order to accommodate the complex motion of a camming tree stand.

### BRIEF DESCRIPTION OF THE SEVERAL VIEWS OF THE DRAWINGS

FIG. 1 is a perspective view, showing a prior art climbing stick.

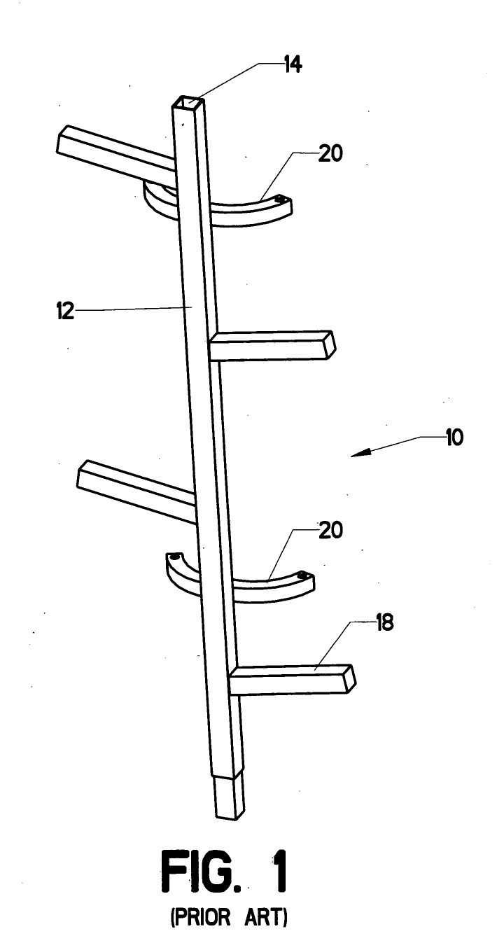

FIG. 2 is a detail view, showing certain features of a prior art climbing stick.

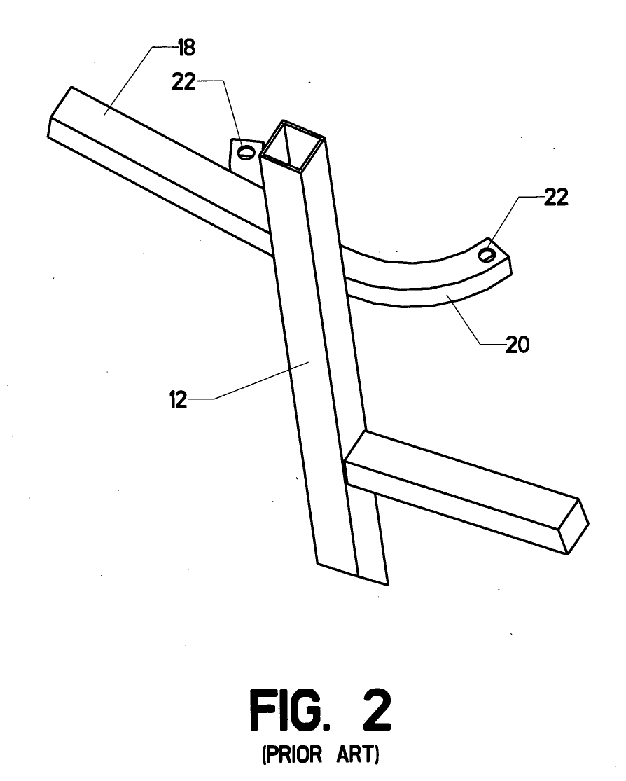

FIG. 3 is a perspective view, showing a strap attached to the climbing stick.

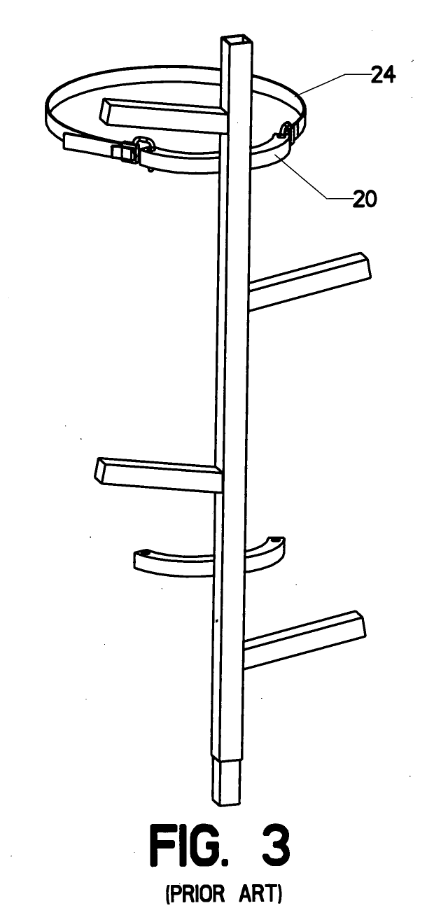

FIG. 4 is a detail view, showing how the strap attaches to the climbing stick.

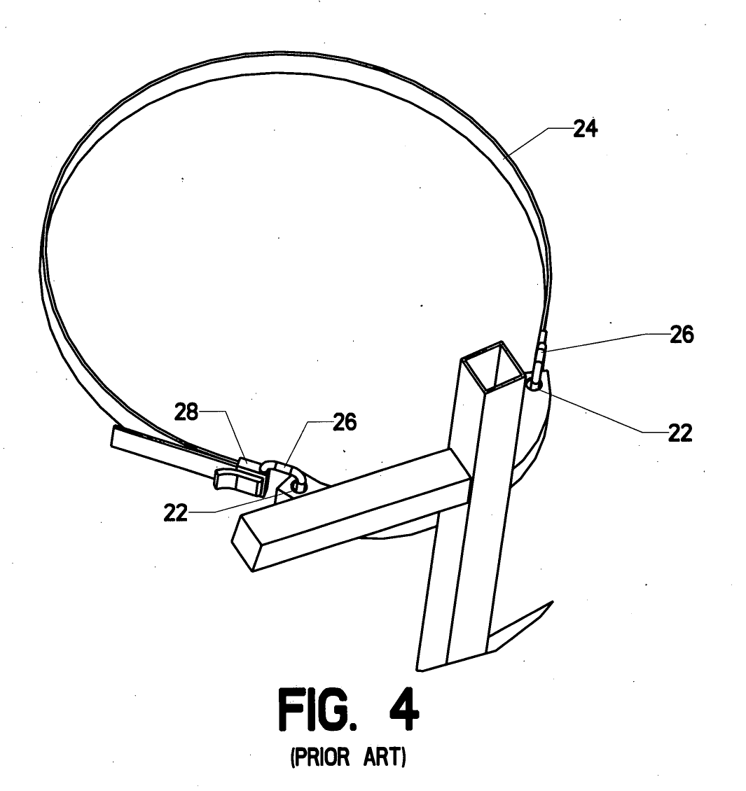

FIG. 5 is a perspective view, showing a climbing stick attached to a tree.

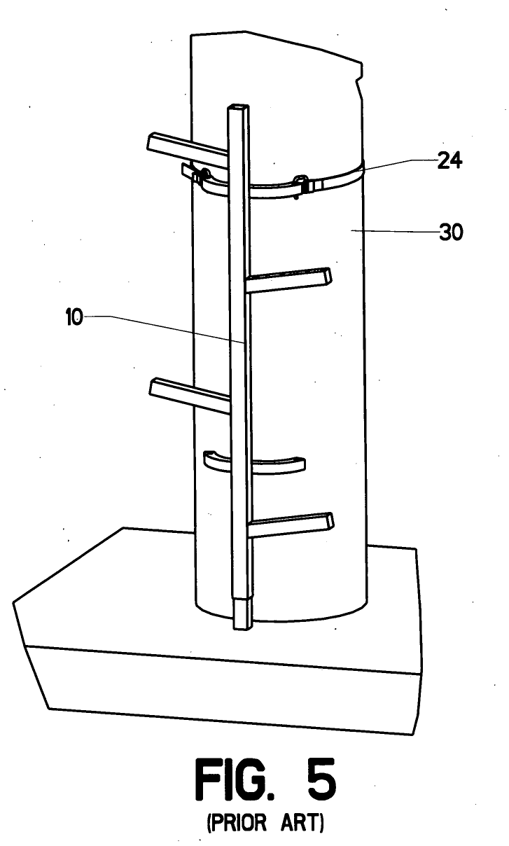

FIG. 6 is a perspective view, showing a prior art tree stand.

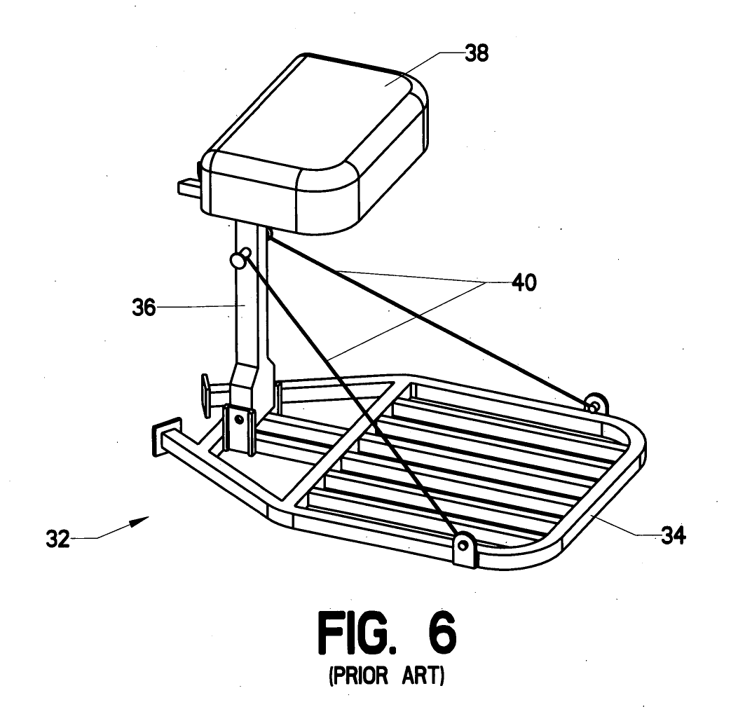

FIG. 7 is a perspective view, showing the tree stand of FIG. 6 in a folded state.

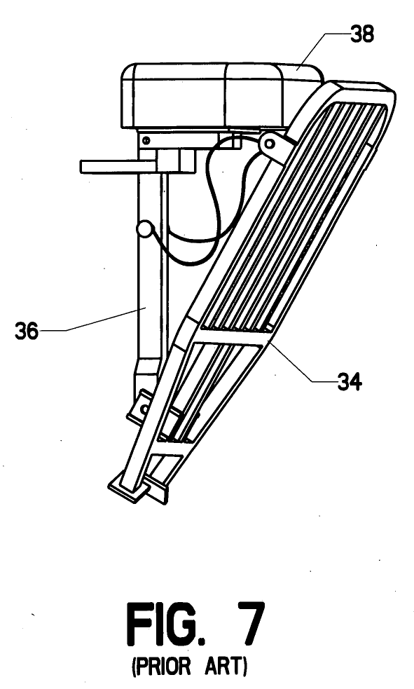

FIG. 8 is a perspective view, showing how a camming tree stand attaches to a tree.

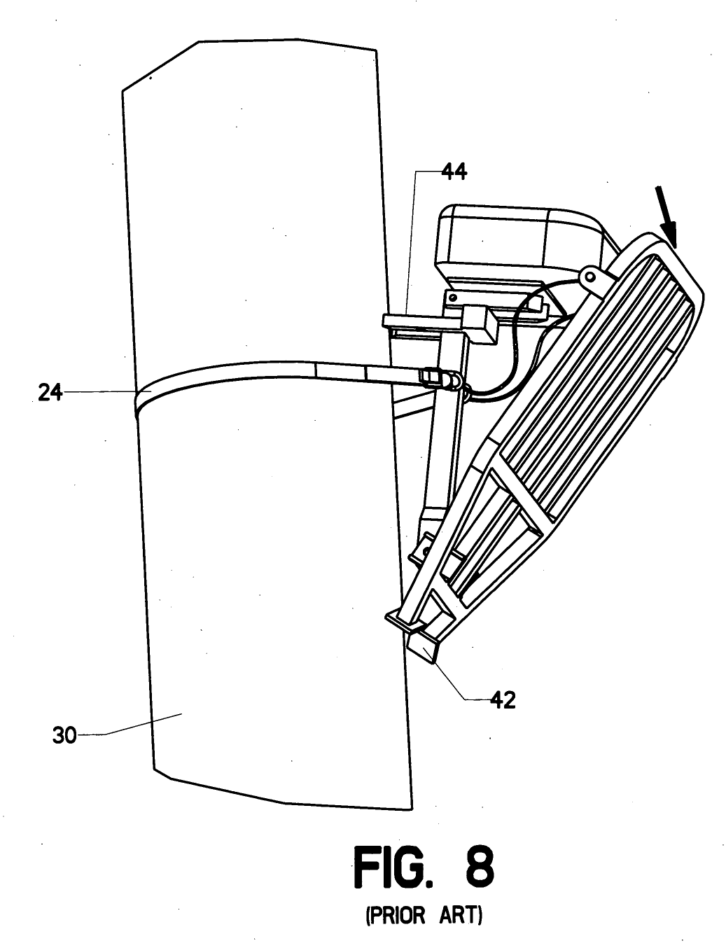

FIG. 9 is a perspective view, showing a camming tree stand attached to a tree.

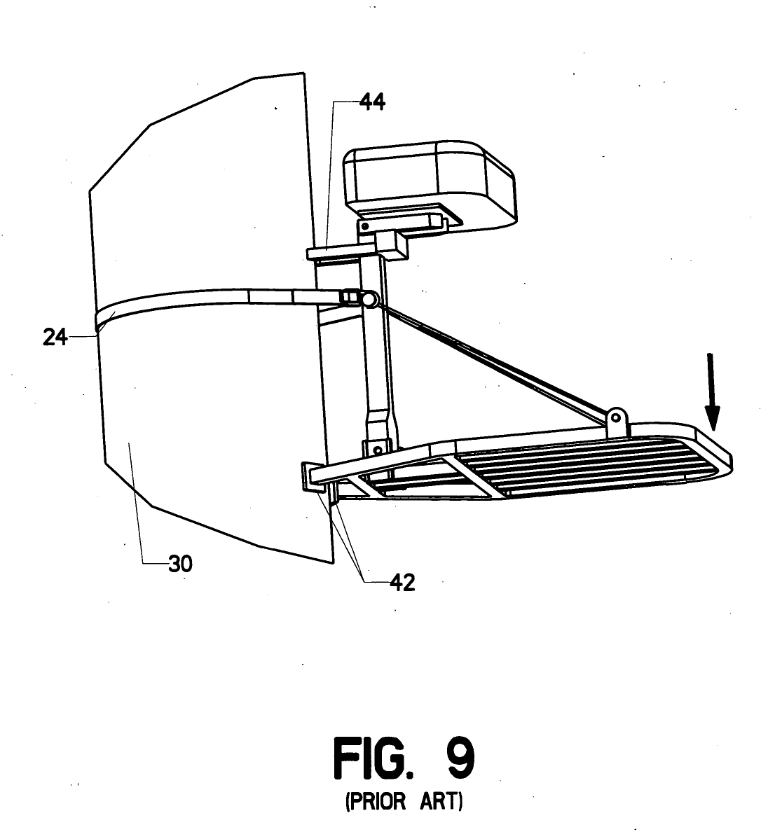

FIG. 10 is a perspective view, showing a typical installation of a prior art modular ladder and tree stand.

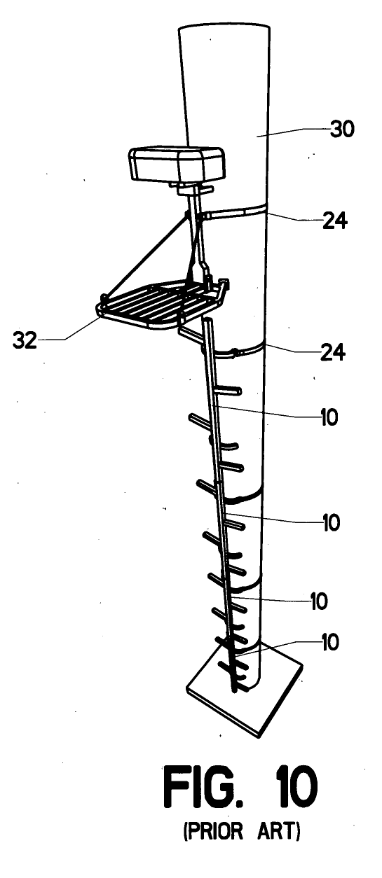

FIG. 11 is a perspective view, showing a climbing stick modified according to the present invention.

FIG. 12 is a detail view, showing a receiver added to a climbing stick.

FIG. 13 is a perspective view, showing a tree stand modified according to the present invention.

FIG. 14 is an exploded perspective view, showing a pivotal attachment between a climbing stick and a tree stand.

FIG. 15 is a perspective view, showing the components of FIG. 14 in an assembled state.

FIG. 15B is a detail view, showing the use of a locking pin to secure the pivot joint.

FIG. 16 is a perspective view, showing a tree stand assembly.

FIG. 17 is a perspective view, showing the tree stand assembly being rotated up against a tree.

FIG. 18 is a perspective view, showing a tree stand pivotally attached to a modified climbing stick.

FIG. 19 is a perspective view, showing a tree stand pivoting away from a modified climbing stick.

FIG. 20 is a detail view, showing how a separate receiver can be attached to a prior art climbing stick.

FIG. 21 is a perspective view, showing the addition of a swing link to create two pivot joints.

FIG. 22 is a detail view, showing the swing link and associated components.

FIG. 23 is a perspective view, showing the operation of the swing link with a camming tree stand.

FIG. 24 is a perspective view, showing the operation of the swing link with a camming tree stand.

### REFERENCE NUMERALS IN THE DRAWINGS

10 climbing stick
12 column
14 receiver
16 extension
18 rung
20 standoff
22 hole
24 strap
26 hook
28 adjustment clasp
30 tree
32 tree stand
34 foot rest
36 upright
38 seat
40 cable
42 pad
44 upper jaw
45 cylinder
46 modified climbing stick
48 receiver
50 extension
52 mounting arm
54 pivot joint
58 tree stand assembly
60 receiver mount
62 bracket
64 fastener
65 swing link
66 extension
68 extension
70 hole
78 hole
80 first pivot joint
84 second pivot joint

### DESCRIPTION OF THE INVENTION

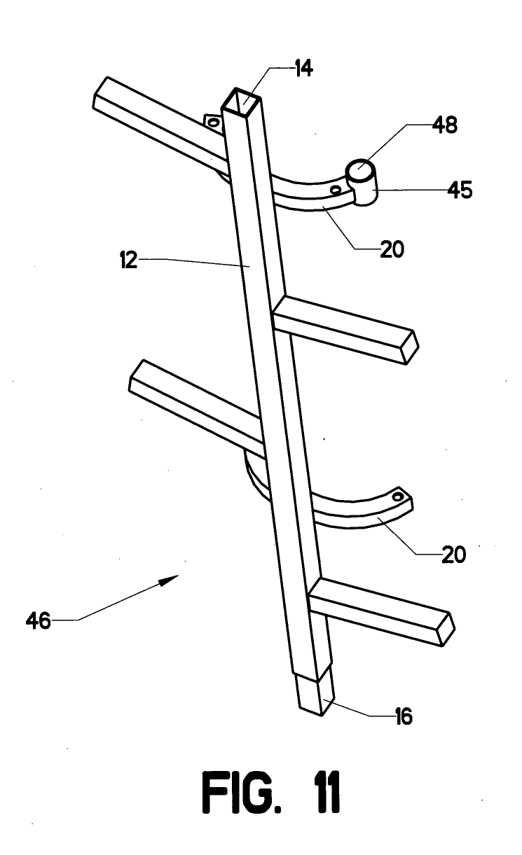

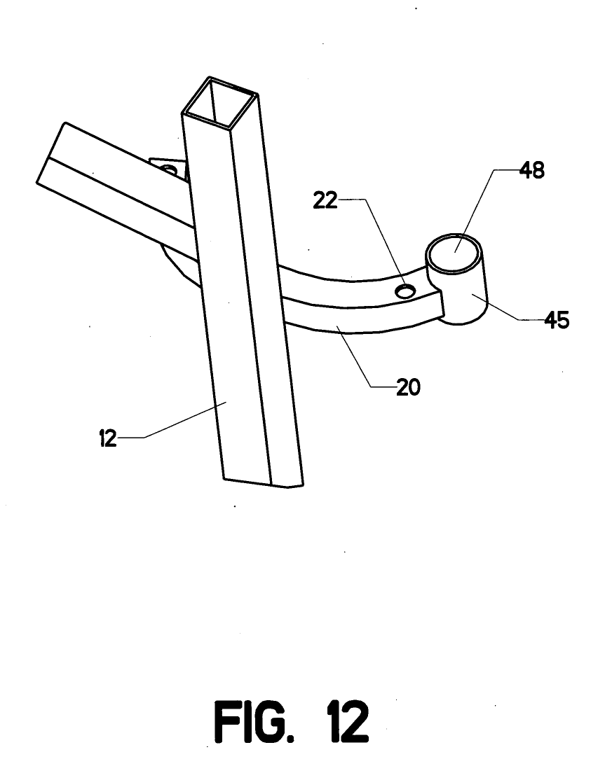

FIG. 11 shows a prior art climbing stick modified according to the present invention. The device is designated as modified climbing stick 46. Cylinder 45 has been added to the upper standoff 20. This cylinder opens into a hollow receiver 48. FIG. 12 shows a detailed view of cylinder 45 and receiver 48. Hole 22 has been slightly relocated in order to accommodate the cylinder.

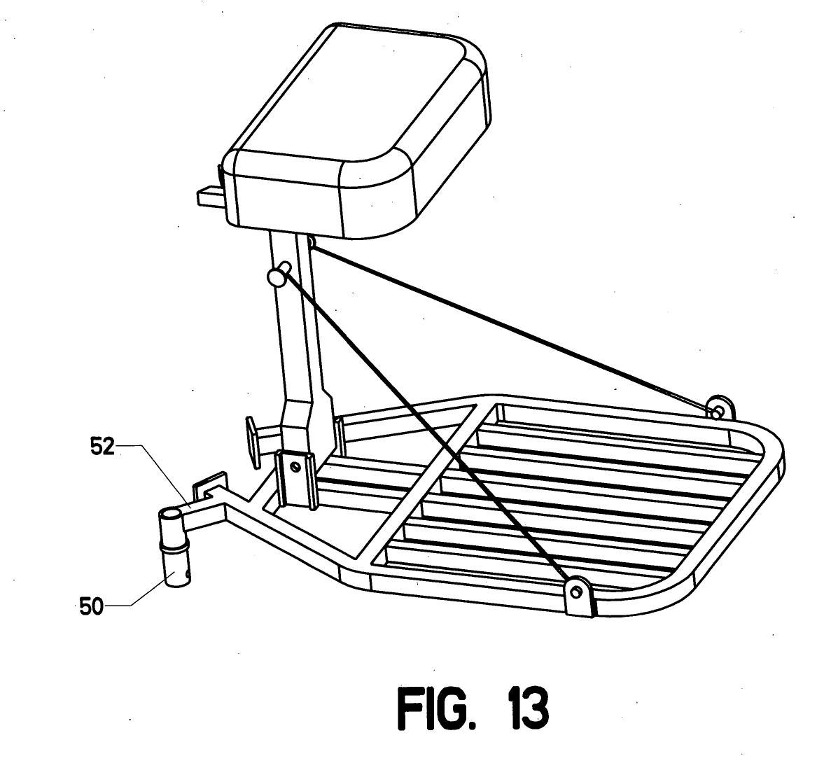

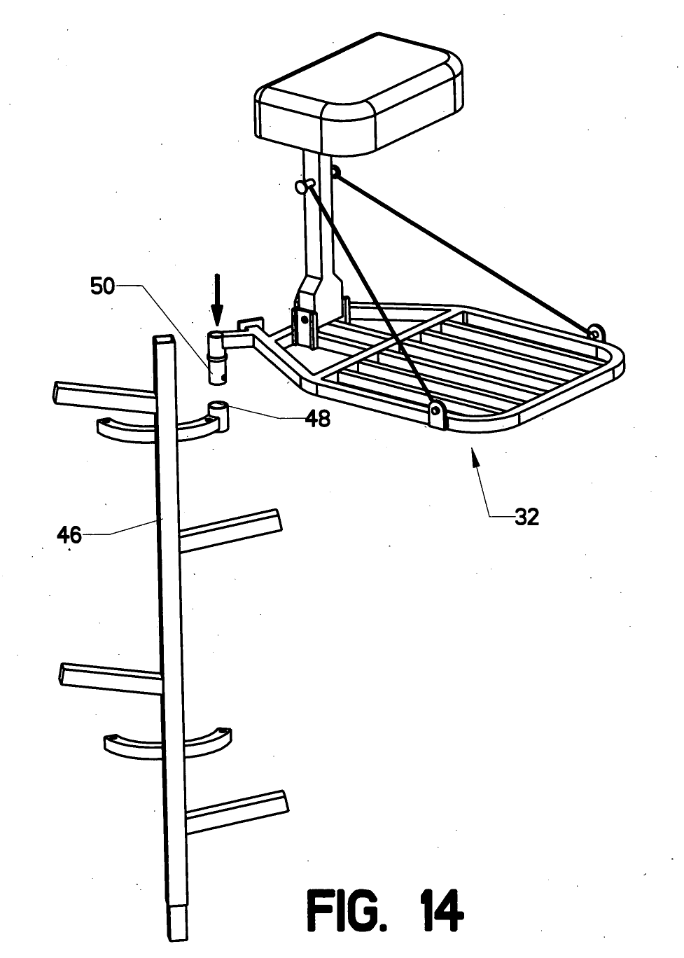

FIG. 13 shows the corresponding modification to a tree stand. Mounting arm 52 has been attached the footplate. It includes a descending extension 50. FIG. 14 shows how extension 50 slips inside receiver 48, thereby forming a pivot joint. The reader should note that mounting arm 52 and extension 50 could be attached to a prior art tree stand at many different points and by many different methods (such as welding, mechanical fasteners, a clamping bracket, etc.). Likewise, receiver 48 could be attached to a prior art climbing stick at many different points and many different methods. The embodiment shown is only one example among many.

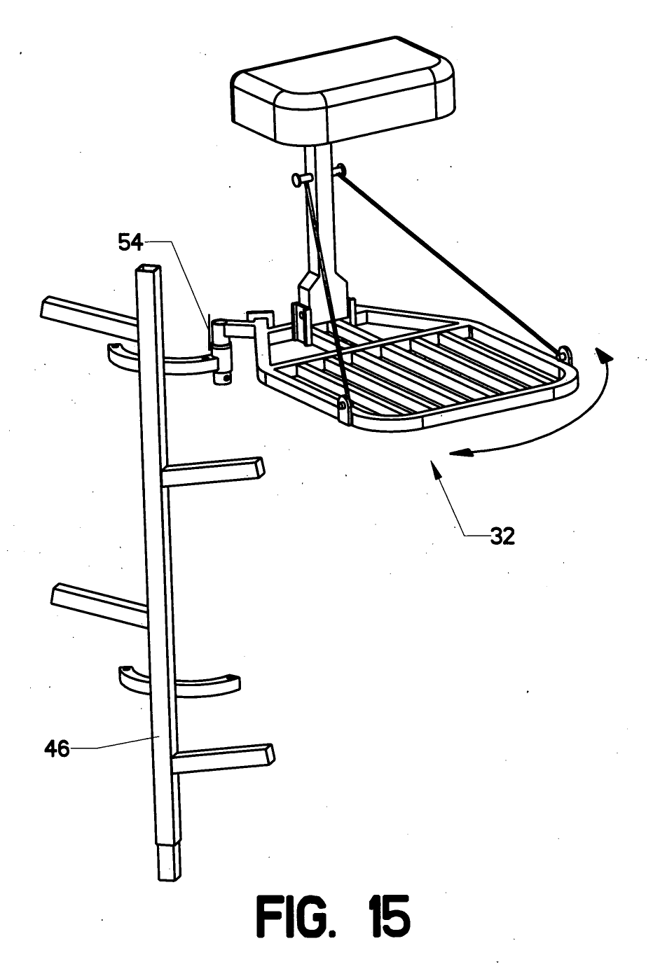

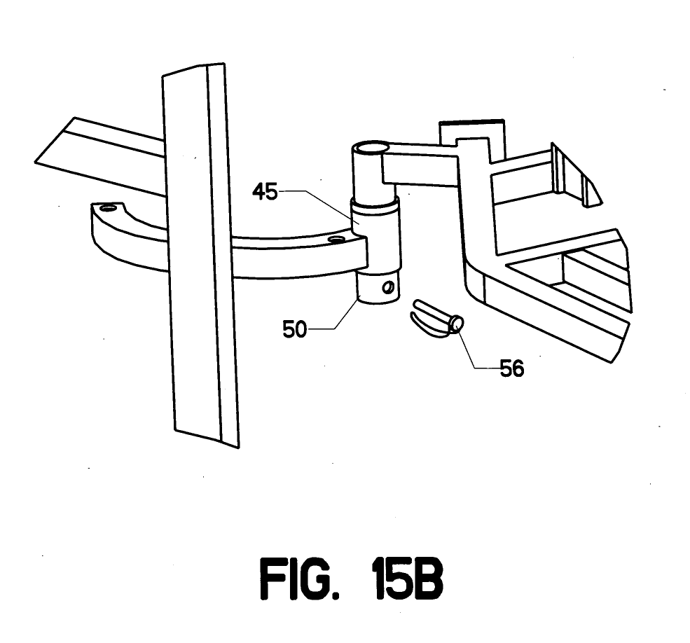

FIG. 15 shows extension 50 securely placed within receiver 48, thereby forming pivot joint 54. Tree stand 32 is pivotally connected to modified climbing stick 46. It is free to pivot in the direction indicated by the arrows. FIG. 15B shows a closer view of the pivot joint. Extension 50 is preferably made long enough to extend out the bottom of cylinder 45. A transverse hole through the extension can then be provided. If the user wishes to lock the tree stand and ladder together, he or she places locking pin 56 through this transverse hole. This securely locks the tree stand and ladder together—even if the assembly is inverted. By removing the locking pin, the user can disassemble the pivot joint in order to separately transport and store the components. Other retaining devices can be substituted for the locking pin, such as a transverse bolt, a lanyard, or a mechanical toggle.

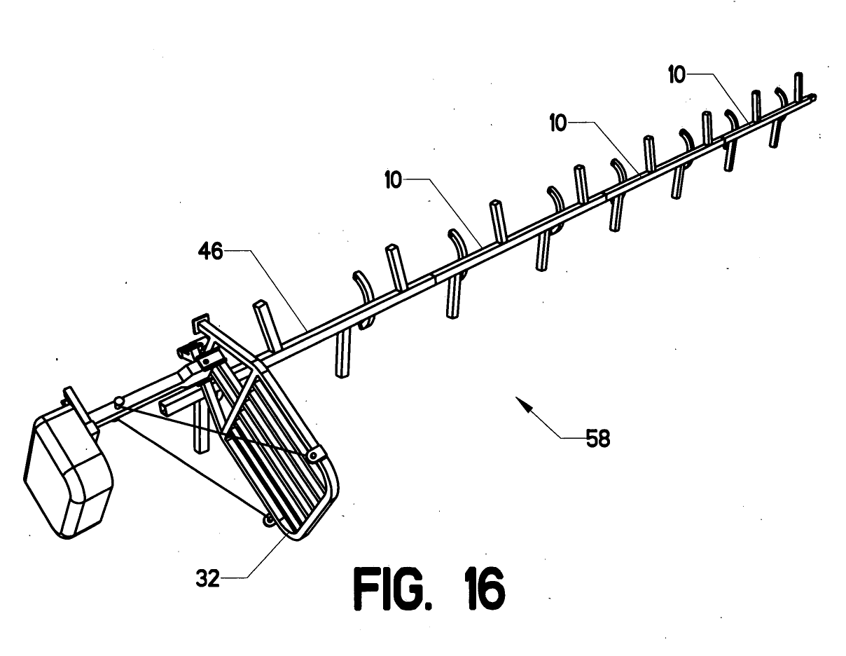

FIGS. 16-19 illustrate the assembly and installation of the integrated ladder and tree stand. The devices are preferably assembled on the ground. Two or more climbing sticks are assembled together, with the number of climbing sticks being determined by the height desired. Modified climbing stick 46 is placed near what will become the top of the ladder. Tree stand 32 is then attached to modified climbing stick 46 by pivot joint 54. The completed assembly is designated as tree stand assembly 58.

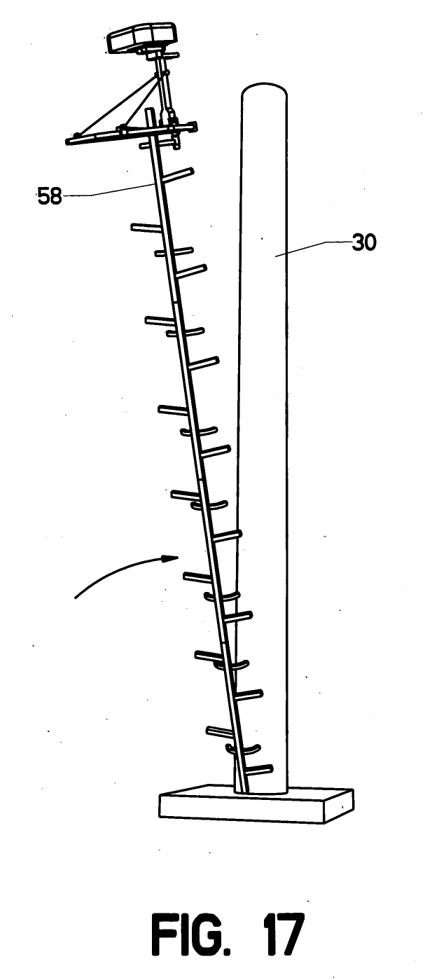

FIG. 17 shows tree stand assembly 58 being erected against a tree 30. All the components used are preferably made of a light material—such as aluminum—so that the weight of the assembly remains manageable. The assembly is erected by the user grasping its lower end and pivoting it upward as shown. The user then secures one of the lower climbing sticks to the tree using a securing strap (as for the prior art).

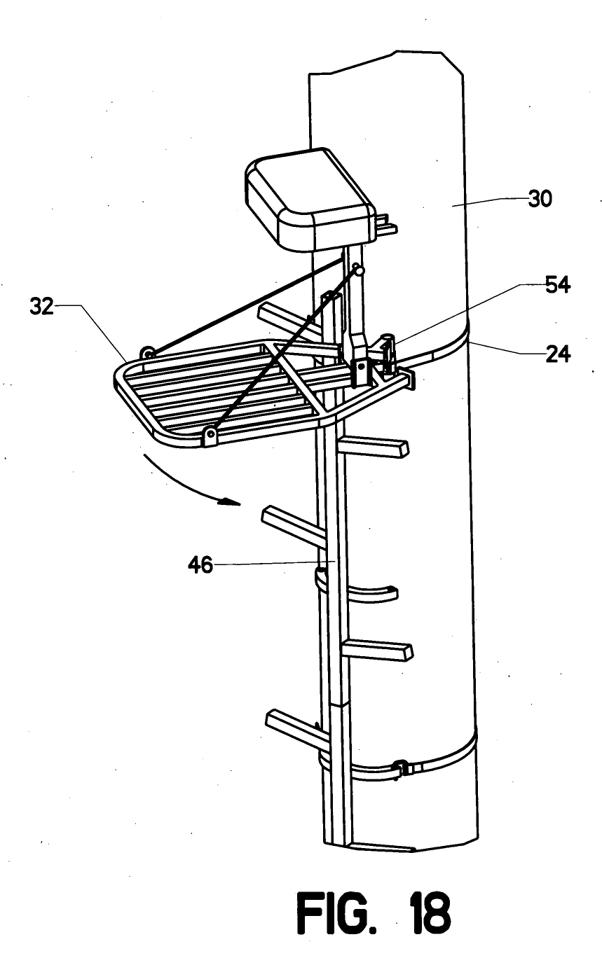

Next, the user climbs the linked climbing sticks, adding additional securing straps as appropriate. Those skilled in the art will know that the user will preferably wear a safety harness attached around the tree. FIG. 18 shows the top of the ladder, after the user has added appropriate straps 24 to secure the ladder to the tree. At this point the reader will observe that the prior art concern of the tree stand lying over the top of the ladder remains. However, thanks to pivot joint 54, the user simply reaches up and pivots the tree stand off to the side as indicated by the arrow.

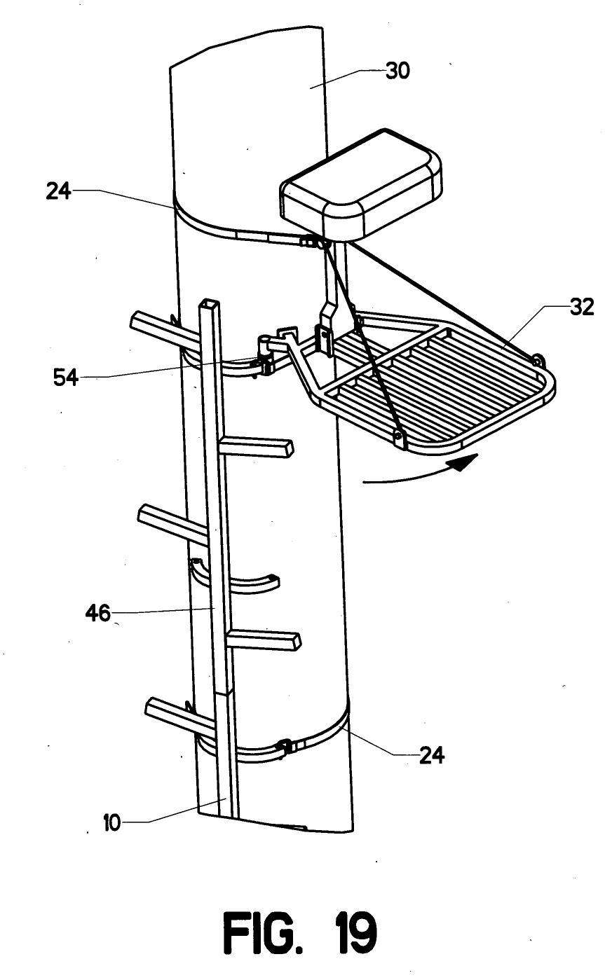

FIG. 19 shows tree stand 32 pivoted away from the top of the ladder and against tree 30. An additional strap 24 can then be added to secure tree stand 32 to tree 30. Those skilled in the art will realize that the result is a mechanically stable assembly. The user can climb to the top of the ladder and then step laterally onto the three stand. If desired, another climbing stick can be attached to the top of modified climbing stick 46 in order to provide extra rungs to grip during the transfer to the tree stand. In other words, pivot joint 54 need not be located near the very top of the ladder.

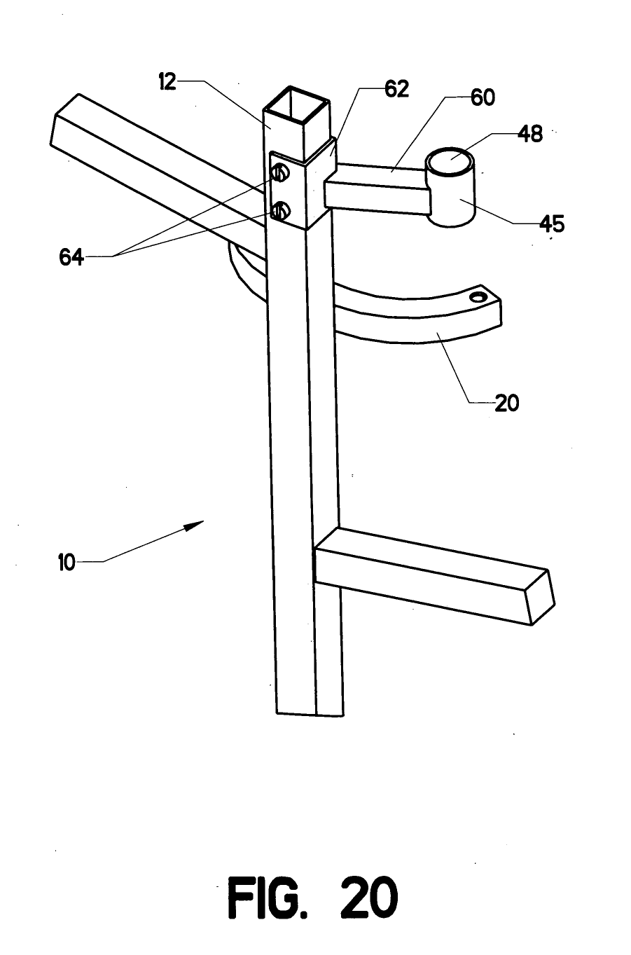

Having thus gained an understanding of the pivot joint and its attachment to the tree stand, the reader will appreciate that the pivot joint itself can be created using virtually endless combinations of mechanical devices. FIG. 20 shows one such variation. Rather than attaching cylinder 45 to one of the standoffs, a separate receiver mount 60 has been provided. It can be welded to the climbing stick. Alternatively, it can be attached using a bracket 62 and mechanical fasteners 64 (Such a bracket can obviously be used to provide a receiver on an unmodified, prior art climbing stick). Many other attachment means are known to those skilled in the art.

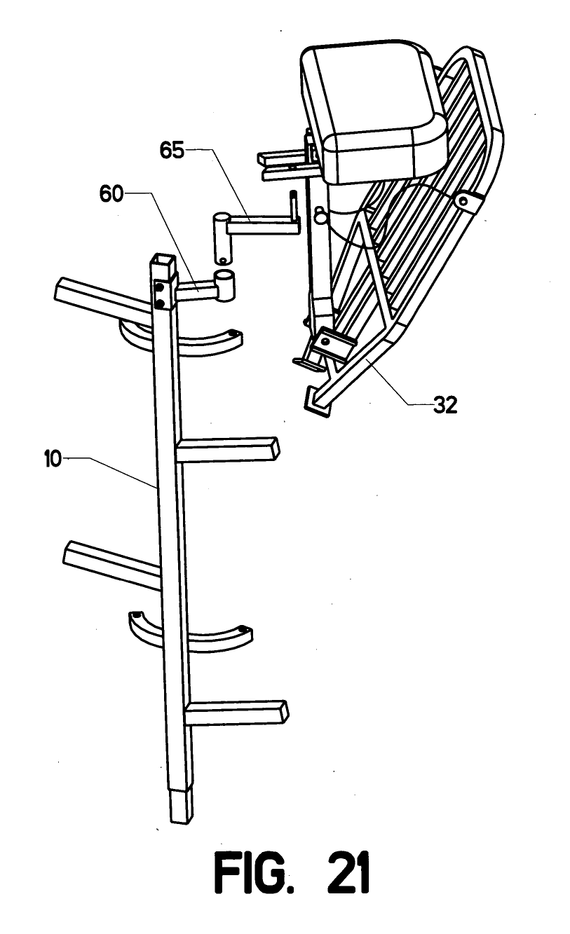

Of course, the simple pivot joint shown in FIGS. 11-19 may not work well for camming tree stands. As described previously, a camming stand tends to translate away from the tree when the foot rest is forced downward. An accommodation for this translation is preferable. FIGS. 21 through 24 show such an accommodation.

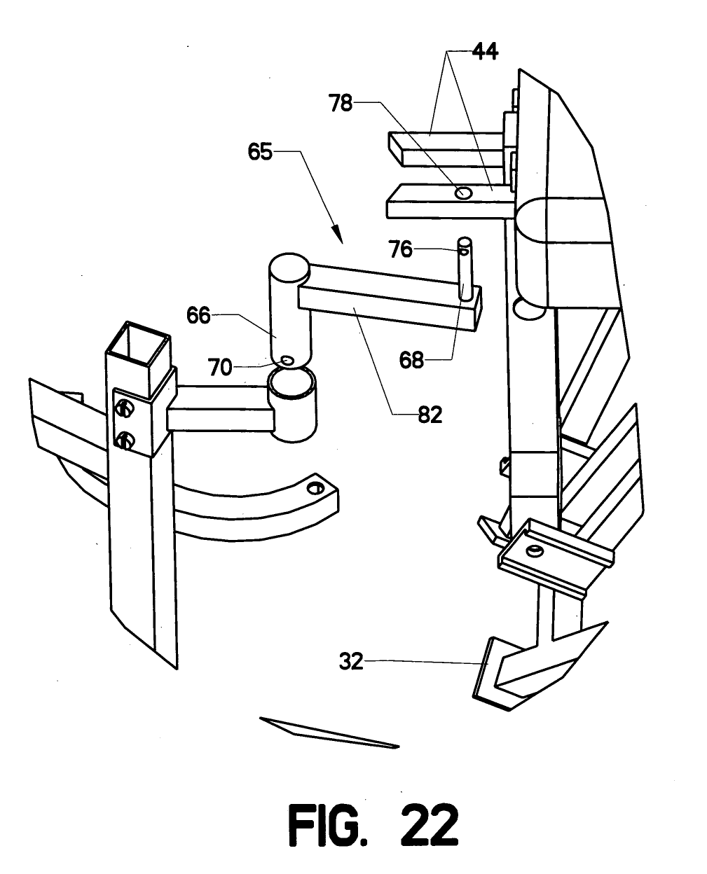

FIG. 21 shows a climbing stick with a receiver mount 60 and receiver 48 added. Swing link 65 is added to create a dual pivot joint arrangement. FIG. 22 shows swing link 65 is more detail. It has two ends joined by arm 82. The first end mounts a descending extension 66 sized to rotatably fit within receiver 48. The second end includes an ascending extension 68 sized to rotatably fit within hole 78 on the tree stand. For this particular version, hole 78 is located in upper jaw 44 of the tree stand. Hole 78 can, of course, be located on many different portions of the tree stand. Hole 70 is provided in extension 66, while hole 76 is provided in extension 68. Locking pins can be placed in these holes to lock the pivot joints together.

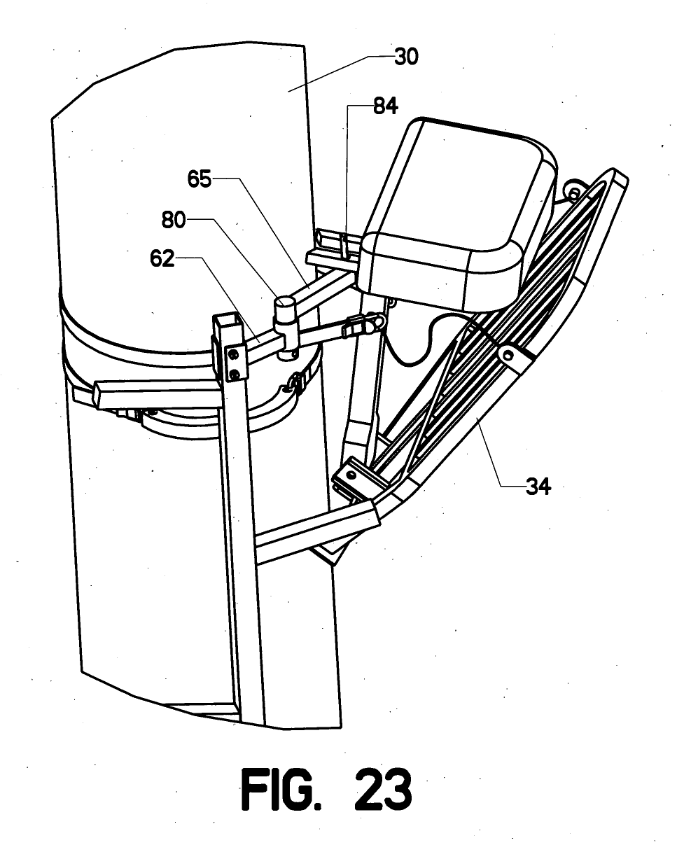

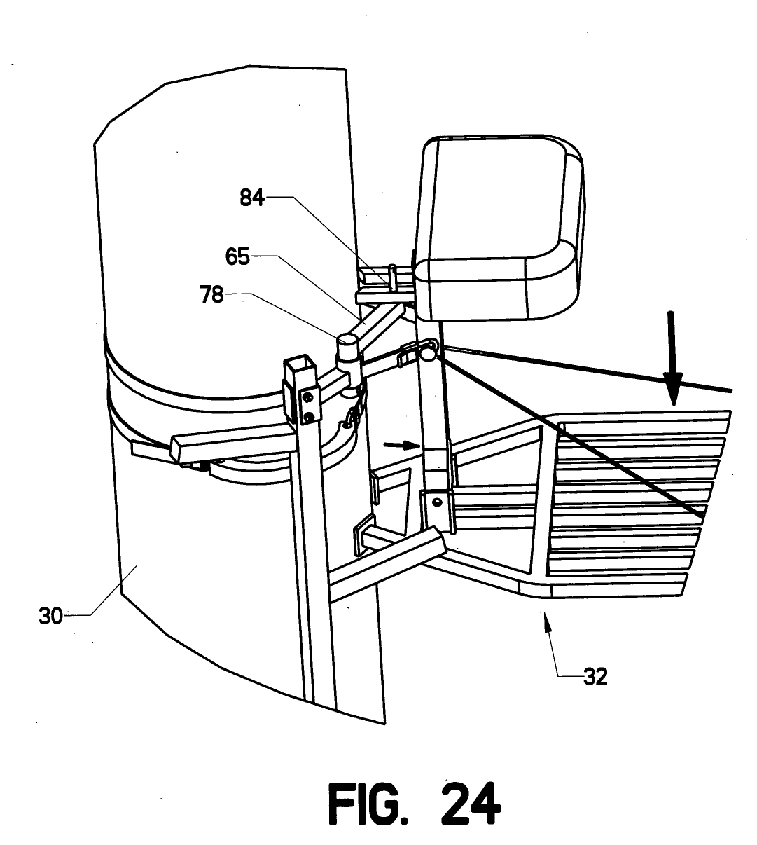

FIG. 23 shows the device in an assembled state. The inclusion of the swing link creates first pivot joint 80 and second pivot joint 84. In the position shown, the camming tree stand's securing strap is put in place. Foot rest 34 is then forced downward. FIG. 24 shows the camming stand locked in place. Swing link 65 has rotated slightly outward—away from the tree. Its presence, along with the two pivot joints, has allowed the translating motion needed to accommodate the camming stand. Second pivot joint 84 is also preferably made a bit “sloppy” (extension 68 is made a bit smaller than hole 78) in order to allow the stand to pitch upward slightly during the camming motion.

Although the preceding description contains significant detail, it should not be construed as limiting the scope of the invention but rather as providing illustrations of the preferred embodiment of the invention. Thus, the scope of the invention should be fixed by the following claims, rather than by the examples given.

Having described my invention, I claim:

1. An integrated ladder and tree stand for attachment to a tree, comprising:
a. a ladder, including a first support column having an upper end, a lower end, and a plurality of rungs;
b. attachment means for securing said first support column to said tree;
c. a tree stand; and
d. a pivot joint between said ladder and said tree stand.

2. An integrated ladder and tree stand as recited in claim 1, wherein said pivot joint between said ladder and said tree stand comprises:
a. a receiver attached to said first support column; and
b. an extension attached to said tree stand and sized to rotatably fit within said receiver.

3. An integrated ladder and tree stand as recited in claim 2, wherein said receiver is attached to said first support column by welding.

4. An integrated ladder and tree stand as recited in claim 3, wherein said receiver is attached to said first support column by a removable fastener.

5. An integrated ladder and tree stand as recited in claim 2, further comprising second attachment means for attaching said tree stand to said tree.

6. An integrated ladder and tree stand as recited in claim 2, wherein said pivot joint is detachable so that said tree stand can be separated from said ladder.

7. An integrated ladder and tree stand as recited in claim 6, wherein said pivot joint is selectably locked together by a retaining device.

8. An integrated ladder and tree stand as recited in claim 1, wherein:
a. said ladder includes a second support column attached to said first support column; and
b. said second support column includes a plurality of rungs.

9. An integrated ladder and tree stand as recited in claim 8, wherein:
a. said ladder includes a third support column attached to said second support column; and
b. said third support column includes a plurality of rungs.

10. A tree stand configured to attach to a ladder, comprising:
a. a tree stand;
b. a bracket, pivotally attached to said tree stand; and
c. wherein said bracket has fastening means configured to attach said bracket to said ladder.

11. A tree stand as recited in claim 10, wherein said pivotal attachment between said bracket and said tree stand can be separated, so that said bracket may remain attached to said ladder while said tree stand is separated from said ladder.

12. An integrated ladder and tree stand for attachment to a tree, comprising:
a. a ladder, including a first support column having an upper end, a lower end, and a plurality of rungs;
b. attachment means for securing said first support column to said tree;
c. a tree stand;
d. a swing link, having a first end and a second end;
e. a first pivot joint between said ladder and said first end of said swing link; and
f. a second pivot joint between said tree stand and said second end of said swing link.

13. An integrated ladder and tree stand as recited in claim 12, wherein said first pivot joint between said ladder and said swing link comprises:
a. a receiver attached to said first support column; and
b. an extension attached to said swing link and sized to rotatably fit within said receiver.

14. An integrated ladder and tree stand as recited in claim 13, wherein said receiver is attached to said first support column by welding.

15. An integrated ladder and tree stand as recited in claim 14, wherein said receiver is attached to said first support column by a removable fastener.

16. An integrated ladder and tree stand as recited in claim 12, further comprising second attachment means for attaching said tree stand to said tree.

17. An integrated ladder and tree stand as recited in claim 12, wherein said first pivot joint is detachable so that said tree stand can be separated from said ladder.

18. An integrated ladder and tree stand as recited in claim 17, wherein said first pivot joint is selectably locked together by a retaining device.

19. An integrated ladder and tree stand as recited in claim 12, wherein:
a. said ladder includes a second support column attached to said first support column; and
b. said second support column includes a plurality of rungs.

20. An integrated ladder and tree stand as recited in claim 12, wherein:
a. said ladder includes a third support column attached to said second support column; and
b. said third support column includes a plurality of rungs.
